(19) United States
(12) Patent Application Publication
(10) Pub. No.: US 2021/0367224 A1
(43) Pub. Date: Nov. 25, 2021

(54) METHOD FOR MANUFACTURING ANODES FOR LITHIUM-ION BATTERIES

(71) Applicant: I-TEN, Dardilly (FR)

(72) Inventor: Fabien GABEN, Dardilly (FR)

(21) Appl. No.: 17/049,448

(22) PCT Filed: May 6, 2019
(86) PCT No.: PCT/FR2019/051027

§ 371 Date: Oct. 21, 2020

(30) Foreign Application Priority Data
May 7, 2018 (FR) 1853912

(51) Int. Cl. H01M 4/04; H01M 4/58; H01M 4/587; H01M 4/485; H01M 4/36; H01M 10/0525

(52) U.S. Cl. CPC H01M 4/0445; H01M 4/5825; H01M 4/587; H01M 4/485; H01M 2004/027; H01M 4/0457; H01M 4/366; H01M 10/0525; H01M 4/0428

(57) ABSTRACT

Anode for a lithium-ion battery, including at least one anode material and being binder-free, said anode being precharged with lithium ions, characterized in that said anode material, deposited on an electronic conductor substrate capable of serving as anode current collector, is coated with a protective coating in contact with said anode material, said protective coating being capable of protecting said anode material from the atmosphere of the environment.

The anode can be deposited from a vapor phase or by electrophoresis, and the protective coating by ALD or chemically in solution.

### FIELD OF THE INVENTION

This invention relates to the field of secondary batteries and particularly lithium-ion batteries. It relates more particularly to thin-film lithium-ion batteries. The invention relates to a new method for manufacturing anodes for these batteries. The invention also relates to a method for manufacturing an electrochemical device, in particular of the battery type; comprising at least one of these anodes, and the devices thus obtained.

### STATE OF THE ART

A secondary lithium-ion battery, resulting from the method of manufacturing thereof, is normally discharged: it includes an electrode charged with lithium (this electrode is called cathode) and an electrode that does not contain lithium ions (this electrode is called anode). During the process of charging the battery lithium ions are extracted from the cathode (which acts like an anode during charging) and migrate through the electrolyte to the anode (which acts like a cathode during charging) where they are inserted into the structure of the anode material; electrons circulating in the external charge circuit reduce the anode and oxidize the cathode. All the reactions at the electrodes must be reversible, so that the battery can reach a high number of charging and discharging cycles.

In all-solid-state lithium-ion batteries the transport of lithium ions in the electrolyte and in the electrodes is done by diffusion in the solid, as these batteries do not include any liquid phase; the electrolyte and the electrodes generally have the form of thin layers in order to limit the series resistance of the device. These batteries and the layers thereof can be deposited by electrophoresis; they are known for example in patent applications WO 2013/064 772, WO 2013/064 773, WO 2013/064 774, WO 2013/064 776, WO 2013/064 779, WO 2013/064 781, WO 2014/102 520, WO 2014/131 997, WO 2016/001 579, WO 2016/001 584, WO 2016/001 588, WO 2017/115 032 (I-TEN).

There may be several specific problems with these batteries.

They are manufactured in the discharged state, i.e. all the lithium is inserted into the cathode.

During the first charge the lithium will exit from the cathode to be inserted into the anode; this can lead to an irreversible structural transformation within the anode. When a large quantity of lithium remains irreversibly inserted in the anode, the capacity of the final battery is slightly reduced as well as its operating voltage range.

In order to try to compensate for the irreversible losses at the first charging of the anode, i.e. this drop in capacity, it is possible to provide a capacity of the cathode that is greater with respect to that of the anode or it is possible to provide that the cathode materials contain after manufacturing excess lithium.

It is known that during the first charging of the batteries, the anodes have irreversible losses. In other words, a portion of the lithium inserted into the structure of the anode material can no longer be released during the discharging of the battery. These losses are all the more so substantial on anode materials of the nitride or oxynitride type.

For example, the publication “Characteristics of tin nitride thin-film negative electrode for thin-film microbattery” of Park et al, published in 2001 in the journal Journal of Power

Sources vol. 103, p. 67-71, describes that the capacity of a lithium-ion battery at the first charging is about 750 μA h/cm² μm then stabilizes at about 250 μA h/cm² μm. In order to ensure good reversibility of the reactions at the electrodes, it is necessary to respect an operating range between 0.2 V and 0.8 V for a capacity of about 200 μA h/cm² μm. In this example, the anode was made of tin nitride. The publication “Synthesis and Electrochemical Characterization of novel Category Si₃₋ₓ.MₓN₄ (M=Co, Ni, Fe) Anodes for rechargeable Lithium Batteries” of N. Kalaiselvi (Int. J. Electrochem. Sci, vol 2 (2007), p. 478-487) observes a similar degradation, but not as strong, in lithium-ion batteries with anodes made of silicon nitrides, of which a portion of the silicon can be substituted with Co, Ni or Fe.

Document WO2015/133139 (Sharp Kabushiki Kaisha) describes an anode precharged with lithium that can limit the effects of irreversible capacity loss during the first charges. The method described in this document is however very difficult to implement because of the high reactivity of the metal lithium with respect to the atmosphere and humidity. It involves either a step wherein the anode materials are mixed with lithium powder under argon, or a step wherein the anode material is reduced with a lithium compound, or a step of electrochemically reducing the lithium. Once the lithium is introduced into the anode, the anode must be protected from humidity and oxygen during later manufacturing steps.

Yet another problem occurs when the method of manufacturing the battery involves an annealing of the electrodes (which will generally be the case with all-solid-state batteries, without a liquid phase): this annealing can lead to a loss of lithium which is detrimental for the operation of the battery. In certain cases the annealing can also cause the formation of parasite products. For example, when anodes made of Li₄Ti₅O₁₂ are used, traces of impurities of the TiO₂ type may appear in the electrodes according to the heat treatment conditions used. These impurities form phases that disturb the operation of the cell, because their lithium insertion potential (1.55 V) is different from that of the Li₄Ti₅O₁₂ (1.7 V).

Furthermore, it is observed that certain electrolyte materials, such as for example amorphous polyethylene oxide PEO, are able to be irreversibly inserted during the first charge with lithium.

Another problem is that once the first charge is complete, the anodes become sensitive to contact with the atmosphere. In light of these many difficulties it would be preferable to avoid the phenomenon instead of compensating for these consequences.

This invention aims to present a method for manufacturing microbatteries with electrodes and a more stable electrolyte. More particularly, it is desired to overcome irreversible capacity losses, whether in the electrodes and/or certain solid electrolyte films covering the electrodes. It is also desired to have anodes that do not show any significant irreversible loss at the first charge.

### PURPOSES OF THE INVENTION

According to the invention, the problem is resolved by using a protective coating on the anodes that protects them from the atmosphere of the environment, and in particular from oxygen, carbon dioxide and humidity. This protective coating can be applied to the anode film and/or to the powder particles of the anode material. It is preferably deposited by the atomic layer deposition technique known by the acronym ALD (Atomic Layer Deposition). Its thickness is preferably less than 5 nm. The ALD technique makes it possible to create dense layers that are free from holes with a very thin thickness; these coatings are very tight. This coating can in particular be made of Li₃PO₄ or of alumina. It can be coated with a solid electrolyte film, for example a layer of LLZO deposited from nanoparticles.

The invention can be implemented for any type of anode that can be used with lithium-ion batteries.

In a first embodiment the anode can be a dense anode, for example an all-solid-state anode deposited by electrophoresis of monodispersed nanoparticles contained in a suspension, such as described in application WO 2013/064773, or by vapor deposition. In this case the anode is covered with a protective coating before the charging with lithium and before the assembly of the battery. This protective coating can be of a very thin thickness and can be done by atomic layer deposition ALD or chemically in a solution known under the acronym CSD (Chemical Solution Dissolution). An electronic insulator can for example be used, in particular an oxide such as silica, alumina or zirconia; the thickness of such as coating preferably does not exceed 2 to 3 nm. However, the level of tightness of such a coating with respect to the atmosphere depends on its thickness, and it is advantageous to further deposit a coating of a solid and dense electrolyte, also resistant to the atmosphere, to improve the protection of the anode after charging with lithium and before assembly to form a battery. The coating of solid and dense electrolyte can be deposited by ALD or chemically in a solution CSD, in so far as that is possible, or, for complex stoichiometries, by any other suitable technique. Said thin layer of electronic insulator deposited by ALD or chemically in a solution CSD also limits the parasite reactions at the interfaces between the solid electrolyte coating and the anode.

In a second embodiment the anode can be a porous anode, preferably mesoporous that has a network of nanoparticles interconnected by an ion conduction path, while leaving pores, preferably mesopores; the latter can be filled with a liquid ionic conductor, for example an ionic liquid including a dissolved lithium salt. According to the invention a porous anode, preferable mesoporous, is protected by a dense coating deposited by ALD or chemically in a solution CSD before precharging with lithium. This coating is advantageously an electronic insulator, in particular an oxide such as silica, alumina or zirconia, but a layer of solid electrolyte can also be deposited.

The invention can be implemented in any type of lithium-ion battery.

In any case using this coating makes it possible to precharge the anode with lithium without fear that the lithium reacts with the air or humidity during the battery assembly steps, or a fortiori during the use thereof.

A first object of the invention is an anode for a lithium-ion battery, including at least one anode material and being binder-free, said anode being precharged with lithium ions, characterized in that said anode material, deposited on an electronic conductor substrate capable of serving as anode current collector, is coated with a protective coating in contact with said anode material, said protective coating being capable of protecting said anode material from the atmosphere of the environment.

The anode according to the invention can be porous, preferably mesoporous.

It can be manufactured by a chemical vapor deposition technique, in particular by a physical vapor deposition technique such as cathode sputtering, and/or by a chemical vapor deposition technique, possibly plasma assisted.

Alternatively it can be manufactured by an electrophoretic deposition technique from a suspension of nanoparticles of at least one anode material, or by dipping. Advantageously, said suspension of nanoparticles, i.e. colloidal suspension can include nanoparticles of at least one anode material with a primary diameter D50 less than or equal to 50 nm.

Alternatively, said colloidal suspension can include aggregates of nanoparticles of anode material. Advantageously, said protective coating comprises a first layer, in contact with the anode material, deposited by the ALD technique (Atomic Layer Deposition) or chemically in a solution CSD, this first layer has a thickness less than 10 nm, preferably less than 5 nm, and that is even more preferably comprised between 1 nm and 3 nm.

Advantageously this first layer is an electronic insulator oxide, preferably selected from the group formed by silica, alumina and zirconia. Advantageously, said protective coating comprises a second layer, deposited on top of the first layer, that is made of a material selected from the group formed by:
phosphates such as Li₃PO_{4,} LiPO₃, (Li₃Al_{0.4}Sc_{1.6}(PO₄)₃, Li_{1.2}Zr_{1.9}Ca_{0.1}(PO₄)₃; LiZr₂(PO₄)₃; Li₁₊₃ₓZr₂(P₁₋ₓSiₓO₄)₃ with 1.8<x<2.3; Li_{1.6x}Zr₂(P₁₋ₓBₓO₄)₃ with 0≤x≤0.25; Li₃(Sc₂₋ₓMₓ)(PO₄)₃ with M=Al or Y and 0≤x≤1; Li₁₊ₓMₓ(Sc)₂₋ₓ(PO₄)₃ with M=Al, Y, Ga or a mixture of the three compounds and 0≤x≤0.8; Li₁₊ₓMₓ(Ga_{1-y}Sc_{y})₂₋ₓ(PO₄)₃ with 0≤x≤0.8; 0≤y≤1 and M=Al or Y or a mixture of the two compounds; Li₁₊ₓMₓ(Ga)₂₋ₓ(PO₄)₃ with M=Al, Y or a mixture of the two compounds and 0≤x≤0.8; Li₁₊ₓAlₓTi₂₋ₓ(PO₄)₃ with 0≤x≤1, Li_{1.3}Al_{0.3}Ti_{1.7}(PO₄)₃, or Li₁₊ₓAlₓGe₂₋ₓ(PO₄)₃ with 0≤x≤1; or Li_{1+x+z}Mₓ(Ge_{1-y}Ti_{y})₂₋ₓSi_{z}P_{3-z}O₁₂ with 0≤x≤0.8 and 0≤y≤1.0 & 0≤z≤1.6 and M=Al, Ga or Y or a mixture of two or three of these compounds; Li_{3+y}(Sc₂₋ₓMₓ)Q_{y}P_{3-y}O₁₂, with M=Al and/or Y and Q=Si and/or Se, 0≤x≤0.8 and 0≤y≤1; or Li_{1+x+y}MₓSc₂₋ₓQ_{y}P_{3-y}O₁₂, with M=Al, Y, Ga or a mixture of the three compounds and Q=Si and/or Se, 0≤x≤0.8 and 0≤y≤1; or Li_{1+x+y+z}Mₓ(Ga_{1-y}Sc_{y})₂₋ₓQ_{z}P_{3-z}O₁₂ with 0≤x≤0.8; 0≤y≤1; 0≤z≤0.6 with M=Al or Y or a mixture of the two compounds and Q=Si and/or Se; or Li₁₊ₓZr₂₋ₓBₓ(PO₄)₃ with 0≤x≤0.25; or Li₁₊ₓZr₂₋ₓCaₓ(PO₄)₃ with 0≤x≤0.25; or Li₁₊ₓNₓM₂₋ₓP₃O₁₂, with 0≤x≤1 and N=Cr, V, Ca, B, Mg, Bi and/or Mo, M=Sc, Sn, Zr, Hf, Se or Si, or a mixture of these compounds;
borates such as Li₃BO₃, LiBO₂, Li₃(Sc₂₋ₓMₓ)(BO₃)₃ with M=Al or Y and 0≤x≤1; Li₁₊ₓMₓ(Sc)₂₋ₓ(BO₃)₃ with 0≤x≤0.8 and M=Al, Y, Ga or a mixture of the three compounds; Li₁₊ₓMₓ(Ga_{1-y}Sc_{y})₂₋ₓ(BO₃)₃ with 0≤x≤0.8; 0≤y≤1 and M=Al or Y; Li₁₊ₓMₓ(Ga)₂₋ₓ(BO₃)₃ with M=Al, Y or a mixture of the two compounds and 0≤x≤0.8; Li₃BO₃—Li₂SO₄, Li₃BO₃—Li₂SiO₄, Li₃BO₃—Li₂SiO₄—Li₂SO₄;
silicates such as Li₂SiO₃, Li₂Si₅O₁₁, Li₂Si₂O₅, Li₂SiO₆, LiAlSiO₄, Li₄SiO₄, LiAlSi₂O₆;
oxides such as a coating of Al₂O₃, LiNbO₃;
fluorides such as AlF₃, LaF₃, CaF₂, LiF, CeF₃;
compounds of the anti-perovskite type chosen from: Li₃OA with A a halide or a mixture of halides, preferably at least one of the elements chosen from F, Cl, Br, I or a mixture of two or three or four of these elements; Li₍₃₋ₓ₎M_{x/2}OA with 0<x≤3, M a divalent metal, preferably at least one of the elements Mg, Ca, Ba, Sr or a mixture of two or three or four of these elements, A a halide or a mixture of halides, preferably at least one of the elements F, Cl, Br, I or a mixture of two or three or four of these elements; Li₍₃₋ₓ₎M³_{x/3}OA with 0≤x≤3, M³ a trivalent metal, A a halide or a mixture of halides, preferably at least one of the elements F, Cl, Br, I or a mixture of two or three or four of these elements; or LiCOX_{z}Y_{(1-z)}, with X and Y halides such as mentioned hereinabove in relation with A, and 0≤z≤1,
a mixture of different compositions contained in said group.

A second object of the invention is a method for manufacturing an anode for lithium-ion battery according to the invention, comprising the steps of:
(a) Deposition of an anode material on said substrate;
(b) Deposition of a protective coating on said anode material;
(c) Charging said anode material with lithium ions by polarization in a solution containing lithium cations.

In this method, the deposition of said anode material can be done by a chemical vapor deposition technique, in particular by a physical vapor deposition technique such as cathode sputtering, and/or by a chemical vapor deposition technique, possibly plasma assisted. Alternatively it can be done by electrophoresis from a suspension of nanoparticles of at least one anode material, or by dipping.

A last object of the invention is a lithium-ion battery, including an anode according to the invention, or including an anode that can be obtained by the method according to the invention, and furthermore including an electrolyte in contact with said anode, and a cathode in contact with said electrolyte.

Said electrolyte is a conductor of lithium ions and is advantageously selected from the group formed by:
all-solid-state electrolytes deposited by vapor phase deposition,
all-solid-state electrolytes electrophoretically deposited,
the electrolytes formed by a separator impregnated with a liquid electrolyte, typically with an aprotic solvent comprising a lithium salt or ionic liquid containing one or more lithium salts or a mixture of the two,
the porous electrolytes, preferably mesoporous, impregnated with a liquid electrolyte, typically with an aprotic solvent comprising a lithium salt or ionic liquid containing one or more lithium salts or a mixture of the two,
the electrolytes comprising a polymer impregnated with a liquid electrolyte and/or a lithium salt,
the electrolytes formed by a lithium-ion-conducting solid electrolyte material, and preferably one for example oxide, sulfide or phosphate.

Said cathode can in particular be an all-solid-state cathode or a porous cathode, preferably mesoporous. It can carry a protective coating, of the same type as that of the anode.

### DETAILED DESCRIPTION OF THE INVENTION

### 1. Definitions

The capacity of an accumulator or battery (in milli-amperes per hour) is the current (in milli-amperes) that can be extracted from a battery in 1 hour. This indicates the autonomy of the battery.

In the context of this document, the particle size is defined by its largest dimension. “Nanoparticle” refers to any particle or object of a nanometric size that has at least one of its dimensions less than or equal to 100 nm.

“Suspension” refers to any liquid in which solid particles are dispersed. In the context of this document, the terms “suspension of nanoparticles” and “colloidal suspension” are used interchangeably. “Suspension of nanoparticles” or “colloidal suspension” refer to any liquid in which solid particles are dispersed.

“Mesoporous materials” refers to any solid that has within its structure pores referred to as “mesopores” that have a size that is intermediate between that of micropores (width less than 2 nm) and that of macropores (width greater than 50 nm), namely a size comprised between 2 nm and 50 nm. This terminology corresponds to that adopted by IUPAC (International Union for Pure and Applied Chemistry), which is a reference for those skilled in the art. Therefore the term “nanopore” is not used here, although mesopores such as defined hereinabove have nanometric dimensions in terms of the definition of nanoparticles, knowing that pores of a size less than that of mesopores are called “micropores” by those skilled in the art.

A presentation of the concepts of porosity (and of the terminology that has just been disclosed hereinabove) is given in the article “Texture des matériaux pulvérulents ou poreux” by F. Rouquerol et al. published in the collection “Techniques de l'Ingénieur”, traité Analyse et Caractérisation, fascicule P 1050; this article also describes the techniques for characterizing porosity, in particular the BET method.

In terms of this invention, “mesoporous electrode” or “mesoporous layer” refers to a layer or electrode that has mesopores. As shall be explained hereinbelow, in these electrodes or layers the mesopores contribute significantly to the total porous volume; this state is referred to using the expression “mesoporous electrode/layer with a mesoporous porosity greater than X % by volume” used in the description hereinbelow.

“Aggregate” means, according to the definitions of UPAC (which are a reference for those skilled in the art), a weakly linked assembly of primary particles. Here, these primary particles are nanoparticles that have a diameter that can be determined by transmission electron microscopy. An aggregate of aggregated primary nanoparticles can normally be destroyed (i.e. reduced to primary nanoparticles) in suspension in a liquid phase under the effect of ultrasound, according to a technique known to those skilled in the art.

### 2. General Points

The invention applies to batteries with electrodes that can be dense or porous, preferably mesoporous. Dense electrodes can be electrophoretically deposited from a suspension comprising non-aggregated nanometric primary particles (monodispersed particles), i.e. the diameter of the particles in the suspension corresponds to their primary diameter. The size of the particles of the anode materials is a critical parameter for the deposition of dense electrodes by electrophoresis, due to their thermal and/or mechanical compaction during which the residual porosity of the layer decreases following the morphological reorganization of the nanoparticles; the driving force of this reorganization is the surface energy and the energy linked to structural defects.

To obtain dense anodes the primary diameter D₅₀ of the particles is advantageously less than 100 nm, preferably less than 50 nm, and even more preferably less than 30 nm. Primary diameter here refers to the diameter of the non-aggregated particles. The same diameter limit is advantageous for the deposition of dense layers of cathode material and electrolyte, to supplement the battery. The zeta potential of these primary nanoparticle suspensions is typically greater than 50 mV in absolute value, and preferably greater than 60 mV. These suspensions can be prepared in different ways, for example directly by hydrothermal synthesis of anode material nanoparticles; in order to obtain a stable suspension it has to be purified in order to decrease (even eliminate) its ionic charge.

According to the invention, anode layers can also be used deposited by a vapor deposition technique, in particular by physical vapor deposition or by chemical vapor deposition, or by a combination of these techniques. Vapor deposition techniques make it possible to especially produce dense layers.

Porous electrodes, preferably mesoporous, can be electrophoretically deposited from a suspension comprising aggregates of primary nanoparticles.

When a porous layer is depositing is electrophoretically deposited, a suspension is used wherein the primary particles are at least partially aggregated. These aggregates have a dimension advantageously comprised between 80 nm and 300 nm, preferably between 100 nm and 200 nm. Such a suspension can be prepared having nanoparticles at least partially aggregated directly by hydrothermal synthesis of said primary nanoparticles: these suspensions are stable only when they have been purified, i.e. free from their residual ionic charge. It is therefore possible to obtain a suspension of nanoparticles that is at least partially aggregated by partial purification of a suspension resulting from the hydrothermal synthesis. Alternatively it is possible to use a purified suspension and destabilize it by adding ions, for example a lithium salt such as LiOH. The zeta potential of such a suspension is typically less than 50 mV in absolute value, and preferably less than 45 mV.

According to the invention, the layers of the battery, and in particular the anode, are binder-free. The electrode layers are typically deposited on substrates able to be used as current collectors; in a manner known as such a metal foil or a polymer foil coated with a conducting layer made from metal or from oxide can be used.

According to the invention the anode can be made in particular from an anode material chosen from:
carbon nanotubes, graphene, graphite;
lithium iron phosphate, of typical formula LiFePO₄;
mixed silicon and tin oxinitrides, of typical formula SiₐSn_{b}O_{y}N, with a>0, b>0, a+b≤2, 0<y≤4, 0<z≤3), also called SiTON, and in particular SiSn_{0.87}O_{1.2}N_{1.72};
oxynitride carbides of typical formula SiₐSn_{b}C_{c}O_{y}N, with a>0, b>0, a+b≤2, 0<c<10, 0<y<24, 0<z<17;
nitrides of the type SiₓN_{y} (in particular with x=3 and y=4), SnₓN_{y} (in particular with x=3 and y=4), ZnₓN_{y} (in particular with x=3 and y=2), Li₃₋ₓMₓN (with 0≤x≤0.5 for M=Co, 0≤x≤0.6 for M=Ni, 0≤x≤0.3 for M=Cu); Si₃₋ₓMₓN₄ with 0≤x≤3.
oxides SnO₂, SnO, Li₂SnO₃, SnSiO₃, LiₓSiO_{y} (x>=0 and 2>y>0), Li₄Ti₅O₁₂, TiNb₂O₇, Co₃O₄, SnB_{0.6}P_{0.4}O_{2.9} and TiO₂,
composite oxides TiNb₂O₇ comprising between 0% and 10% carbon by weight, preferably carbon being chosen from graphene and the carbon nanotubes.

The morphology and the structure of the anode layers depend on their deposition technique, and those skilled in the art are able to distinguish for example between a dense layer deposited by electrophoresis, a dense layer deposited by vapor deposition, and a porous or mesoporous layer deposited by electrophoresis. For example, the so-called dense electrode layers deposited by electrophoresis according to the technique described in WO 2013/064773 have a density that is at least 80%, and preferably at least 90%, and even more preferably at least 95% of the theoretical density of the massive solid. The layers deposited by vapor deposition on the other hand are generally rather homogeneous, porosity-free, and can possibly have columnar growth. The porous layers, preferably mesoporous deposited by electrophoresis have a specific morphology, characterized by a network of pores, preferably mesopores, that appears on transmission electron microscopies.

This electronic conductor substrate that can be used as a current collector can be metallic, for example a metal foil, or a polymeric foil or metalized non-metallic (i.e. coated with a layer of metal). The substrate is preferably chosen from foils made from titanium, copper, nickel or stainless steel.

The metal foil can be coated with a layer of noble metal, in particular chosen from gold, platinum, titanium or alloys containing mostly at least one or more of these metals, or with a layer of conductive material of the ITO type (which has the advantage of also acting as a diffusion barrier).

Using massive materials, in particular foils made of titanium, copper or nickel, also makes it possible to protect the cut edges of the electrodes of batteries from corrosion phenomena.

Stainless steel can also be used as a current collector, in particular when it contains titanium or aluminum as alloy element, or when it has on the surface a thin layer of protective oxide.

Other substrates used as a current collector can be used such as less noble metal foils covered with a protective coating, making it possible to prevent any dissolution of these foils induced by the presence of electrolytes in contact with them.

These less noble metal foils can be foils made of Copper, Nickel or foils of metal alloys such as foils made of stainless steel, foils of Fe—Ni alloy, Be—Ni—Cr alloy, Ni—Cr alloy or Ni—Ti alloy.

The coating that can be used to protect the substrates used as current collectors can be of different natures. It can be a:
thin layer obtained by sol-gel process of the same material as that of the electrode. The absence of porosity in this film makes it possible to prevent contact between the electrolyte and the metal current collector.
thin layer obtained by vacuum deposition, in particular by physical vapor deposition (PVD) or by chemical vapor deposition (CVD), of the same material as that of the electrode,
thin metal layer, dense, without defects, such as a thin metal layer of gold, titanium, platinum, palladium, tungsten or molybdenum. These metals can be used to protect the current collectors because they have good conduction properties and can resist heat treatments during the subsequent method of manufacturing electrodes. This layer can in particular be prepared by electrochemistry, PVD, CVD, evaporation, ALD.
thin layer of carbon such as diamond carbon, graphic, deposited by ALD, PVD, CVD or by inking of a sol-gel solution making it possible to obtain after heat treatment a carbon-doped inorganic phase to make it conductive.

The coating that can be used to protect the substrates used as current collectors must be electronically conductive in order to not harm the operation of the electrode deposited later on this coating, by making it too resistive.

Generally, in order to not excessively impact the operation of the battery cells, the maximum dissolution currents measured on the substrates, at the operating potentials of the electrodes, expressed in μA/cm², must be 1000 times less that the surface capacities of the electrodes expressed in μAh/cm².

### 3. Treatment of the Anode Layer after the Deposition Thereof

The layers deposited by electrophoresis require a specific treatment after the deposition thereof, and first of all they must be dried after having been separated from contact with the suspension from which they were deposited. The drying must not induce the formation of cracks. For this reason it is preferred to carry it out in controlled humidity and temperature conditions. The step of drying of the anode material layer takes place, preferably, between the end of the deposition by electrophoresis and the beginning of the deposition of the protective coating.

The step of drying the anode layer can be done at atmospheric pressure, preferably at a temperature comprised between 30° C. and 120° C. Drying under pressure reduces the risk of weakening the layer due to the violent departure of liquid evaporated from the sub-surface zones of the layer.

Due to the size of the particles and the melting temperature thereof, the step of drying can either be limited to the elimination of the liquid phase of the suspension, or carrying out the consolidation of the layer. Also, according to the nature of the materials that these layers are formed from, their crystalline state, their particle size, the anode layer can be subjected after drying to an optional annealing, possibly preceded and/or accompanied by a pressing. This can be necessary in order to optimize the electrochemical properties of the anode films.

The heat treatment of anode materials deposited to form porous anodes is described in the chapter “Alternatives” hereinbelow.

### 4. Protection of the Anode Layer

The deposition of the protective coating (also called protection coating) is done before the precharging of the anode layer. For layers deposited by electrophoresis, this is done after drying and/or consolidation. The purpose of the protective coating is to protect the precharged anode from the atmosphere in order to prevent the lithium from exiting the anode in contact with the atmosphere. It is applied on the anodes, before the assembly of the battery. It plays the role of a protective layer. The latter prevents the formation of secondary products which lower the insertion capacity of the lithium cations. It also prevents the anodes from losing their lithium ions inserted into their structure.

The protective coating must be dense and solid. In an advantageous embodiment it is deposited by ALD or chemically in a solution CSD. These deposition techniques by ALD and by CSD make it possible to carry out an encapsulating coating that truly reproduces the topography of the substrate; it lines the entire surface of the electrodes.

Its thickness is advantageously less than 10 nm, and advantageously greater than 2 nm in order to guarantee a good barrier effect. The coatings obtained by ALD or CSD are very protective even when they are of a thin thickness, because they are dense in that they are free of holes (“pinhole”). In addition they are sufficiently thin to not alter the performance of the anode. For a dense layer (hole-free) the water vapor transmission rate (WVTP) decreases with the thickness of the layer.

Advantageously, the deposition of the protective coating comprises the deposition by ALD or by CSD of a layer of an electronically insulating material, preferably selected from alumina, silica or zirconia, or from a lithium-ion-conducting solid electrolyte material, preferably Li₃PO_{4,} said protective coating having a thickness comprised between 1 nm and 5 nm, preferably between 1 nm and 4 nm, more preferably between 1 nm and 3 nm. For example, the anodes can be covered with a dense and solid protective film made of an ionic and stable conductive material in contact with the atmosphere.

This protective film can be:
a phosphate coating such as a coating of Li₃PO_{4,} LiPO₃, (Li₃Al_{0.4}Sc_{1.6}(PO₄)₃, Li_{1.2}Zr_{1.9}Ca_{0.1}(PO₄)₃; LiZr₂(PO₄)₃; Li₁₊₃ₓZr₂(P₁₋ₓSiₓO₄)₃ with 1.8<x<2.3; Li_{1.6x}Zr₂(P₁₋ₓBₓO₄)₃ with 0≤x≤0.25; Li₃(Sc₂₋ₓMₓ)(PO₄)₃ with M=Al or Y and 0≤x≤1; Li₁₊ₓMₓ(Sc)₂₋ₓ(PO₄)₃ with M=Al, Y, Ga or a mixture of the three compounds and 0≤x≤0.8; Li₁₊ₓMₓ(Ga_{1-y}Sc_{y})₂₋ₓ(PO₄)₃ with 0≤x≤0.8; 0≤y≤1 and M=Al or Y or a mixture of the two compounds; Li₁₊ₓMₓ(Ga)₂₋ₓ(PO₄)₃ with M=Al, Y or a mixture of the two compounds and 0≤x≤0.8; Li₁₊ₓAlₓTi₂₋ₓ(PO₄)₃ with 0≤x≤1, Li_{1.3}Al_{0.3}Ti_{1.7}(PO₄)₃, or Li₁₊ₓAlₓGe₂₋ₓ(PO₄)₃ with 0≤x≤1; or Li_{1+x+z}Mₓ(Ge_{1-y}Ti_{y})₂₋ₓSi_{z}P_{3-z}O₁₂ with 0≤x≤0.8 and 0≤y≤1.0 & 0≤z≤1.6 and M=Al, Ga or Y or a mixture of two or three of these compounds; Li_{3+y}(Sc₂₋ₓMₓ)Q_{y}P_{3-y}O₁₂, with M=Al and/or Y and Q=Si and/or Se, 0≤x≤0.8 and 0≤y≤1; or Li_{1+x+y}MₓSc₂₋ₓQ_{y}P_{3-y}O₁₂, with M=Al, Y, Ga or a mixture of the three compounds and Q=Si and/or Se, 0≤x≤0.8 and 0≤y≤1; or Li_{1+x+y+z}Mₓ(Ga_{1-y}Sc_{y})₂₋ₓQ_{z}P_{3-z}O₁₂ with 0≤x≤0.8; 0≤y≤1; 0≤z≤0.6 with M=Al or Y or a mixture of the two compounds and Q=Si and/or Se; or Li₁₊ₓZr₂₋ₓBₓ(PO₄)₃ with 0≤x≤0.25; or Li₁₊ₓZr₂₋ₓCaₓ(PO₄)₃ with 0≤x≤0.25; or Li₁₊ₓNₓM₂₋ₓP₃O₁₂, with 0≤x≤1 and N=Cr, V, Ca, B, Mg, Bi and/or Mo, M=Sc, Sn, Zr, Hf, Se or Si, or a mixture of these compounds;
a borate coating such as a coating of: Li₃BO₃, LiBO₂, Li₃(Sc₂₋ₓMₓ)(BO₃)₃ with M=Al or Y and 0≤x≤1; Li₁₊ₓMₓ(Sc)₂₋ₓ(BO₃)₃ with 0≤x≤0.8 and M=Al, Y, Ga or a mixture of the three compounds; Li₁₊ₓMₓ(Ga_{1-y}Sc_{y})₂₋ₓ(BO₃)₃ with 0≤x≤0.8; 0≤y≤1 and M=Al or Y; Li₁₊ₓMₓ(Ga)₂₋ₓ(BO₃)₃ with M=Al, Y or a mixture of the two compounds and 0≤x≤0.8; Li₃BO₃—Li₂SO₄, Li₃BO₃—Li₂SiO₄, Li₃BO₃—Li₂SiO₄—Li₂SO₄;
a silicate coating such as a coating of: Li₂SiO₃, Li₂Si₅O₁₁, Li₂Si₂O₅, Li₂SiO₆, LiAlSiO₄, Li₄SiO₄, LiAlSi₂O₆;
an oxide coating such as a coating of Al₂O₃, LiNbO₃;
a fluoride coating such as a coating of: AlF₃, LaF₃, CaF₂, LiF, CeF₃;
a coating of the anti-perovskite type chosen from: Li₃OA with A a halide or a mixture of halides, preferably at least one of the elements chosen from F, Cl, Br, I or a mixture of two or three or four of these elements; Li₍₃₋ₓ₎M_{x/2}OA with 0<x≤3, M a divalent metal, preferably at least one of the elements Mg, Ca, Ba, Sr or a mixture of two or three or four of these elements, A a halide or a mixture of halides, preferably at least one of the elements F, Cl, Br, I or a mixture of two or three or four of these elements; Li₍₃₋ₓ)M³_{x/3}OA with 0≤x≤3, M³ a trivalent metal, A a halide or a mixture of halides, preferably at least one of the elements F, Cl, Br, I or a mixture of two or three or four of these elements; or LiCOX_{z}Y_{(1-z)}, with X and Y halides such as mentioned hereinabove in relation with A, and 0≤z≤1;
a coating composed of a mixture of the different preceding compositions.

The protective film can also be made of an oxide material of the electronic insulator type. It is possible to deposit for example an oxide of the alumina Al₂O₃, silica or zirconia type, especially if the thickness is low, in particularly less than about 5 nm, and preferably comprises between 2 nm and 3 nm. The barrier effect of these layers deposited by ALD increases with their thickness, but as the ALD technique is rather slow it is desired to deposit layers as thin as possible. For porous anode layers, preferably mesoporous it is possible to deposit the protective coating by ALD or by CSD, preferably by ALD; its thickness does not exceed 5 nm. For porous anode layers, preferably mesoporous, the deposition of a protective coating, in particular inside pores of these layers is advantageously done by ALD. This technique makes it possible to coat the inside of the pores, in particular pores of small dimensions, i.e. pores of a few nanometers in diameter.

To deposit on the anodes, and in particular dense anodes, thicker protective coatings in particular of a thickness greater than 5 nm, lithium ion conducting materials are advantageously used, such as just has been explained, to deposit a dense electrolyte coating from nanoparticles. The latter can be deposited on top of a first thin coating deposited by ALD or by CSD, which can be an electronic insulator; this embodiment prevents the reaction of electrolyte materials with the anode material. The stable solid electrolytes in contact with the atmosphere which can be deposited consequently as a protective coating from nanoparticles can be those that have just been listed as a dense and solid protective film to cover the anodes, and can in particular be selected from the group formed by: lithium phosphates, lithium borates, lithium silicates, lithium oxides, lithium antiperovskites, mixtures of these compositions.

Even more particularly, this protective coating comprises at least one compound selected from the group formed by:
garnets, preferably chosen from: Li₇La₃Zr₂O₁₂; Li₆La₂BaTa₂O₁₂; Li_{5.5}La₃Nb_{1.75}In_{0.25}O₁₂; Li₅La₃M₂O₁₂ with M=Nb or Ta or a mixture of the two compounds; Li₇₋ₓBaₓLa₃₋ₓM₂O₁₂ with 0≤x≤1 and M=Nb or Ta or a mixture of the two compounds; Li₇₋ₓLa₃Zr₂₋ₓMₓO₁₂ with 0≤x≤2 and M=Al, Ga or Ta or a mixture of two or three of these compounds;
lithium phosphates, preferably chosen from: Li₃PO₄; LiPO₃; Li₃Al_{0.4}Sc_{1.6}(PO4)3 under the acronym LASP, Li_{1.2}Zr_{1.9}Ca_{0.1}(PO₄)₃; LiZr₂(PO₄)₃; Li₁₊₃ₓZr₂(P₁₋ₓSiₓO₄)₃ with 1.8<x<2.3; Li₁₊₆ₓZr₂(P₁₋ₓBₓO₄)₃ with 0≤x≤0.25; Li₃(Sc₂₋ₓMₓ)(PO₄)₃ with M=Al or Y and 0≤x≤1; Li₁₊ₓMₓ(Sc)₂₋ₓ(PO₄)₃ with M=Al, Y, Ga or a mixture of the three compounds and 0≤x≤0.8; Li₁₊ₓMₓ(Ga_{1-y}Sc_{y})₂₋ₓ(PO₄)₃ with 0≤x≤0.8; 0≤y≤1 and M=Al or Y or a mixture of the two compounds; Li₁₊ₓMₓ(Ga)₂₋ₓ(PO₄)₃ with M=Al, Y or a mixture of the two compounds and 0≤x≤0.8; Li₁₊ₓAlₓTi₂₋ₓ(PO₄)₃ with 0≤x≤1, Li_{1.3}Al_{0.3}Ti_{1.7}(PO₄)₃, or Li₁₋ₓAlₓGe₂₋ₓ(PO₄)₃ with 0≤x≤1; or Li_{1-x+z}Mₓ(Ge_{1-y}Ti_{y})₂₋ₓSi_{z}P_{3-z}O₁₂ with 0≤x≤0.8 and 0 y≤1.0 & 0≤z≤0.6 and M=Al, Ga or Y or a mixture of two or three of these compounds; Li_{3+y}(Sc₂₋ₓMₓ)Q_{y}P_{3-y}O₁₂, with M=Al and/or Y and Q=Si and/or Se, 0≤x≤0.8 and 0≤y≤1; or Li_{1-x+y}MₓSc₂₋ₓQ_{y}P_{3-y}O₁₂, with M=Al, Y, Ga or a mixture of the three compounds and Q=Si and/or Se, 0≤x≤0.8 and 0≤y≤1; or Li_{1+x+y+z}Mₓ(Ga_{1-y}Sc_{y})₂₋ₓQ_{z}P_{3-z}O₁₂ with 0≤x≤0.8; 0≤y≤1; 0≤z≤0.6 with M=Al or Y or a mixture of the two compounds and Q=Si and/or Se; or Li₁₊ₓZr₂₋ₓBₓ(PO₄)₃ with 0≤x≤0.25; or Li₁₊ₓZr₂₋ₓCaₓ(PO₄)₃ with 0≤x≤0.25; or Li₁₊ₓNₓM₂₋ₓP₃O₁₂, with 0≤x≤1 and N=Cr, V, Ca, B, Mg, Bi and/or Mo, M=Sc, Sn, Zr, Hf, Se or Si, or a mixture of these compounds;
lithium borates, preferably chosen from: Li₃(Sc₂₋ₓMₓ)(BO₃)₃ with M=Al or Y and 0≤x≤1; Li₁₋ₓMₓ(Sc)₂₋ₓ(BO₃)₃ with M=Al, Y, Ga or a mixture of the three compounds and 0≤x≤0.8; Li₁₊ₓMₓ(Ga_{1-y}Sc_{y})₂₋ₓ(BO₃)₃ with 0≤x≤0.8; 0≤y≤1 and M=Al or Y; (Li₁₋ₓMₓ(Ga)₂₋ₓ(BO₃)₃ with M=Al, Y or a mixture of the two compounds and 0≤x≤0.8; Li₃BO₃, LiBO₂, Li₃BO₃—Li₂SO₄, Li₃BO₃—Li₂SiO₄, Li₃BO₃—Li₂SiO₄—Li₂SO₄;
oxinitrides, preferably chosen LiPO₄₋ₓN_{2x/3}, Li₄SiO₄₋ₓN_{2x/3}, Li₄GeO₄₋ₓN_{2x/3} with 0<x<4 or Li₃BO₃₋ₓN_{2/3} with 0<x<3;
lithium compounds based on lithium and phosphorus oxinitride (called LiPON) in the form LiₓPO_{y}N_{z} with x˜2.8 and 2y+3z˜7.8 and 0.16≤z≤0.4, and in particular Li_{2.9}PO_{3.3}N_{0.46}, but also the compounds Li_{w}POₓN_{y}S_{z} with 2x+3y+2z=5=w or the compounds Li_{w}POₓN_{y}S_{z} with 3.2≤x≤3.8, 0.13≤y≤0.4, 0≤z≤0.2, 2.9≤w≤3.3 or the compounds in the form of LiₜPₓAl_{y}OᵤNᵥS_{w} with 5x+3y=5, 2u+3v+2w=5+t, 2.9≤t≤3.3, 0.84≤x≤0.94, 0.094≤y≤0.26, 3.2≤u≤3.8, 0.13≤v≤0.46, 0≤w≤0.2;
materials based on lithium phosphorus or boron oxinitrides (called LiPON and LIBON) also able to contain silicon, sulfur, zirconium, aluminum, or a combination of aluminum, boron, sulfur and/or silicon, and boron for the materials based on lithium phosphorus oxinitrides;
lithium compounds based on lithium, phosphorus and silicon oxinitride called LiSiPON, and particularly Li_{1.9}Si_{0.28}P_{1.0}O_{1.1}N_{1.0};
lithium oxinitrides of the LiBON, LiBSO, LiSiPON, LiSON, thio-LiSiCON, LiPONB types (where B, P and S represent boron, phosphorus and sulfur respectively);
lithium oxides, preferably chosen from Li₇La₃Zr₂O₁₂ or Li₅₊ₓLa₃(Zrₓ,A₂₋ₓ)O₁₂ with A=Sc, Y, Al, Ga and 1.4≤x≤2 or Li_{0.35}La_{0.55}TiO₃ or Li₃ₓLa_{2/3-x}TiO₃ with 0≤x≤0.16;
silicates, preferably chosen from Li₂Si₂O₅, Li₂SiO₃, Li₂SiO₆, Li₂Si₂O₆, LiAlSiO₄, Li₄SiO₄, LiAlSi₂O₆, Li₂Si₅O₁₁;
solid electrolytes of the anti-perovskite type chosen from: Li₃OA with A a halide or a mixture of halides, preferably at least one of the elements chosen from F, Cl, Br, I or a mixture of two or three or four of these elements; Li₍₃₋ₓ₎M_{x/2}OA with 0<x≤3, M a divalent metal, preferably at least one of the elements Mg, Ca, Ba, Sr or a mixture of two or three or four of these elements, A a halide or a mixture of halides, preferably at least one of the elements F, Cl, Br, I or a mixture of two or three or four of these elements; Li₍₃₋ₓ₎M³_{x/3}OA with 0≤x≤3, M³ a trivalent metal, A a halide or a mixture of halides, preferably at least one of the elements F, Cl, Br, I or a mixture of two or three or four of these elements; or LiCOX_{z}Y_{(1-z)}, with X and Y halides such as mentioned hereinabove in relation with A, and 0≤z≤1,
the compounds La_{0.51}Li_{0.34}Ti_{2.94}, Li_{3.4}V_{0.4}Ge_{0.6}O₄, Li₂O—Nb₂O₅, LiAlGaSPO₄;
formulations based on Li₂CO₃, B₂O₃, Li₂O, Al(PO₃)₃LiF, P₂S₃, Li₂S, Li₃N, Li₁₄Zn(GeO₄)₄, Li_{3.6}Ge_{0.6}V_{0.4}O₄, LiTi₂(PO₄)₃, Li_{3.25}Ge_{0.25}P_{0.25}S₄, Li_{1.3}Al_{0.31}Ti_{1.7}(PO₄)₃, Li₁₊ₓAlₓM₂₋ₓ(PO₄)₃ (where M=Ge, Ti, and/or Hf, and where 0<x<1), Li_{1+x+y}AlₓTi₂₋ₓSi_{y}P_{3-y}O₁₂ (where 0≤x≤1 and 0≤y≤1), LiNbO₃.

### 5. Precharging of the Anode

Once covered with this protective coating (which can be, in the case of a dense anode, a coating deposited by ALD or by CSD, possibly coated with a dense electrolyte film, and, in the case of a porous anode, of a coating deposited by ALD or by CSD), the anode can be charged with lithium by immersion and polarization in a liquid electrolyte. Several charging and discharging cycles can be carried out to reach an entirely reversible behavior of the anode. The anode thus charged can then be assembled by hot pressing with the cathode without the risk of losing lithium: The solid electrolyte layer that covers the anode prevents the mobile lithium from leaving the anode.

Regarding the step of charging the anode with lithium ions several cases can arise, according to the objective pursued. The method of precharging according to the invention can be done with the purpose of offsetting the irreversible losses at the first charge. In this case, the precharging is carried out by a charging of the anode with lithium from its initial potential to its potential at the end of insertion of the lithium then a new sweeping until a return to the initial potential in order to cause the mobile lithium to exit. This anode that has undergone precharging has a new reversible capacity that is less than that of the first charge It is the value of this capacity of this precharged anode that will be balanced with the capacity of the cathode. This embodiment applies in particular to anodes with a base of nitrides, oxinitrides; it makes it possible to increase the specific energy of the battery elements.

The method of precharging according to the invention can also be carried out with the purpose of optimizing the operating voltage range of the battery cells in order to guarantee excellent performance in cycling, and to offset the defects of the electrodes with a base of Li₄Ti₅O₁₂. Indeed, according to the manufacturing modes, heat treatments of nanoparticles of Li₄Ti₅O₁₂ are able to form oxides of form TiO₂ or neighboring their surfaces. These oxides insert the lithium at 1.7V instead of 1.55V for Li₄Ti₅O₁₂. The voltage of the battery cell being the result of the difference in potential between the cathode and the anode. In order to ensure that the cathode is always within its reversibility range during the operation thereof, it is important to be able to precisely correlate the voltage of the battery cell to the potential of the cathode. For this, it is useful that the anode always operate exclusively at 1.55 V. The potential of the cathode then being that of the battery cell less 1.55 V, it is important to precharge the anode with Li₄Ti₅O₁₂ in order to pass the plateau to 1.7 V and place the anode before assembly at 1.55 V. The reversible capacity of the anode at 1.55 V must be slightly higher than that of the cathode.

The electrodes, preferably coated with a protective layer, for example of ceramic oxide or solid electrolyte, are charged by polarization in a solution containing lithium cations. Once charged, these electrodes can operate in complete cells over an optimized voltage range and without irreversible losses at the first charge.

### 6. Manufacture of the Battery

The anode protected and precharged according to the invention can be suitable with any type of electrolyte that is suitable for a lithium-ion battery.

Advantageously, the electrolyte of the battery can be comprised of:
a separator impregnated with a liquid electrolyte, typically with an aprotic solvent comprising a lithium salt or ionic liquid containing one or more lithium salts or a mixture of the two,
a porous insulator structure, preferably mesoporous, impregnated with a liquid electrolyte, typically with an aprotic solvent comprising a lithium salt or ionic liquid containing one or more lithium salts or a mixture of the two,
a polymer impregnated with a liquid electrolyte and/or a lithium salt, or
a solid electrolyte material (for example oxide, sulfide, phosphate) conducting lithium ions.

Advantageously, when the electrolyte of the battery is composed of a polymer impregnated with a lithium salt, the polymer is preferably chosen from the group formed by polyethylene oxide, polyimides, polyvinylidene fluoride, polyacrylonitrile, polymethyl methacrylate, polysiloxanes, and the lithium salt is preferably chosen from among LiCl, LiBr, LiI, Li(ClO₄), Li(BF₄), Li(PF₆), Li(AsF₆), Li(CH₃CO₂), Li(CF₃SO₃), Li(CF₃SO₂)₂N, Li(CF₃SO₂)₃, Li(CF₃CO₂), Li(B(C₆H₅)₄), Li(SCN), Li(NO₃).

Advantageously, the ionic liquid can be a cation of the type 1-Ethyl-3-methylimidazolium (also called EMI+) and/or n-propyl-n-methylpyrrolidinium (also called PYR₁₃⁺) and/or n-butyl-n-methylpyrrolidinium (also called PYR₁₄⁺), associated with anions of the type bis (trifluoromethanesulfonyl)imide (TFSI⁻) and/or bis(fluorosulfonyl)imide (FSI⁻). To form an electrolyte, a lithium salt of the type LiTFSI can be dissolved in the ionic liquid which is used as a solvent or in a solvent such as γ-butyrolactone. γ-butyrolactone prevents the crystallization of the ionic liquids inducing an operating range in temperature of the latter that is greater, in particular at low temperature. Advantageously, when the porous anode or cathode comprises a lithium phosphate, the phase carrying lithium ions can comprise a solid electrolyte such as LiBH₄ or a mixture of LiBH₄ with one or more compounds chosen from LiCl, LiI and LiBr. LiBH₄ is a good conductor of lithium and has a low melting point that facilitates the impregnation thereof in the porous electrodes, in particular by dipping. Due to is extremely reducing properties, LiBH₄ is little used as an electrolyte. Using a protective film on the surface of porous lithium phosphate electrodes prevents the reduction in electrode materials, in particular cathode materials, by LiBH₄ and prevents degradation of the electrodes.

Advantageously, the phase carrying lithium ions comprises a least one ionic liquid, preferably at least one ionic liquid at ambient temperature, such as PYR14TFSI, possibly diluted in at least one solvent, such as γ-butyrolactone.

Advantageously, the phase carrying lithium ions comprises between 10% and 40% by weight of a solvent, preferably between 30 and 40% by weight of a solvent, and even more preferably between 30 and 40% by weight of γ-butyrolactone.

Advantageously the phase carrying lithium ions comprises more than 50% by weight of at least one ionic liquid and less than 50% solvent, which limits the risks of safety and of ignition in case of malfunction of the batteries comprising such a phase carrying lithium ions.

Advantageously, the phase carrying lithium ions comprises:
between 30 and 40% by weight of a solvent, preferably between 30 and 40% by weight of γ-butyrolactone, and
more than 50% by weight of at least one ionic liquid, preferably more than 50% by weight of PYR14TFSI.

The phase carrying lithium ions can be an electrolytic solution comprising PYR14TFSI, LiTFSI and γ-butyrolactone, preferably an electrolytic solution comprising about 90% by weight of PYR14TFSI, 0.7 M of LiTFSI and 10% by weight of γ-butyrolactone.

Advantageously, the layer of electrolyte material is made from solid electrolyte material chosen from:
garnets of formula Li_{d}A¹ₓA²_{y}(TO₄), where
   A¹ represents a cation of oxidation state +II, preferably Ca, Mg, Sr, Ba, Fe, Mn, Zn, Y, Gd; and where
   A² represents a cation of oxidation state +III, preferably Al, Fe, Cr, Ga, Ti, La; and where
   (TO₄) represents an anion wherein T is an atom of oxidation state +IV, located at the center of a tetrahedron formed by the oxygen atoms, and wherein TO₄ advantageously represents the silicate or zirconate anion, knowing that all or a portion of the elements T of an oxidation state +IV can be replaced by atoms of an oxidation state +III or +V, such as Al, Fe, As, V, Nb, In, Ta;
   knowing that: d is comprised between 2 and 10, preferably between 3 and 9, and even more preferably between 4 and 8; x is 3 but can be comprised between 2.6 and 3.4 (preferably between 2.8 and 3.2); y is 2 but can be comprised between 1.7 and 2.3 (preferably between 1.9 and 2.1) and z is 3 but can be comprised between 2.9 and 3.1;
garnets, preferably chosen from: Li₇La₃Zr₂O₁₂; Li₆La₂BaTa₂O₁₂; Li_{5.5}La₃Nb_{1.75}In_{0.25}O₁₂; Li₅La₃M₂O₁₂ with M=Nb or Ta or a mixture of the two compounds; Li₇₋ₓBaₓLa₃₋ₓMₓO₁₂ with 0≤x≤1 and M=Nb or Ta or a mixture of the two compounds; Li₇₋ₓLa₃Zr₂₋ₓMₓO₁₂ with 0≤x≤2 and M=Al, Ga or Ta or a mixture of two or three of these compounds;
lithium phosphates, preferably chosen from: lithium phosphates of the type NaSICON, Li₃PO₄; LiPO₃; Li₃Al_{0.4}Sc_{1.6}(PO₄)₃ known under the acronym LASP, Li_{1.2}Zr_{1.9}Ca_{0.1}(PO₄)₃; LiZr₂(PO₄)₃; Li₁₊₃ₓZr₂(Pi₁ₓSiₓO₄)₃ with 1.8<x<2.3; Li₁₊₆ₓZr₂(P₁₋ₓBₓO₄)₃ with 0≤x≤0.25; Li₃(Sc₂₋ₓMₓ)(PO₄)₃ with M=Al or Y and 0≤x≤1; Li₁₊ₓMₓ(Sc)₂₋ₓ(PO₄)₃ with M=Al, Y, Ga or a mixture of the three compounds and 0≤x≤0.8; Li₁₊ₓMₓ(Ga_{1-y}Sc_{y})₂₋ₓ(PO₄)₃ with 0≤x≤0.8; 0≤y≤1 and M=Al or Y or a mixture of the two compounds; Li₁₊ₓMₓ(Ga)₂₋ₓ(PO₄)₃ with M=Al, Y or a mixture of the two compounds and 0≤x≤0.8; Li₁₊ₓAlₓTi₂₋ₓ(PO₄)₃ with 0≤x≤1 known under the acronym LATP, or Li₁₊ₓAlₓGe₂₋ₓ(PO₄)₃ with 0≤x≤1 known under the acronym LAGP; or Li_{1+x+z}Mₓ(Ge_{1-y}TiO₂₋ₓSi_{z}P_{3-z}O₁₂ with 0≤x≤0.8 and 0≤y≤1.0 and 0≤z≤0.6 and M=Al, Ga or Y or a mixture of two or three of these compounds; Li_{3+y}(Sc₂₋ₓMₓ)Q_{y}P_{3-y}O₁₂, with M=Al and/or Y and Q=Si and/or Se, 0≤x≤0.8 and 0≤y≤1; or Li_{1+x+y}MₓSc₂₋ₓQ_{y}P_{3-y}O₁₂, with M=Al, Y, Ga or a mixture of the three compounds and Q=Si and/or Se, 0≤x≤0.8 and 0≤y≤1; or Li_{1+x+y+z}Mₓ(Ga_{1-y}Sc_{y})₂₋ₓQ_{z}P₃₋₂O₁₂ with 0≤x≤0.8; 0≤y≤1; 0≤z≤0.6 with M=Al or Y or a mixture of the two compounds and Q=Si and/or Se; or Li₁₊ₓZr₂₋ₓBₓ(PO₄)₃ with 0≤x≤0.25; or Li₁₊ₓZr₂₋ₓCaₓ(PO₄)₃ with 0≤x≤0.25; or Li₁₊ₓNₓM₂₋ₓP₃O₁₂, with 0≤x≤1 and N=Cr, V, Ca, B, Mg, Bi and/or Mo, M=Sc, Sn, Zr, Hf, Se or Si, or a mixture of these compounds;
lithium borates, preferably chosen from: Li₃(Sc₂₋ₓMₓ)(BO₃)₃ with M=Al or Y and 0≤x≤1; Li₁₊ₓMₓ(Sc)₂₋ₓ(BO₃)₃ with M=Al, Y, Ga or a mixture of the three compounds and 0≤x≤0.8; Li₁₊ₓMₓ(Ga_{1-y}Sc_{y})₂₋ₓ(BO₃)₃ with 0≤x≤0.8; 0≤y≤1 and M=Al or Y; Li₁₊ₓMₓ(Ga)₂₋ₓ(BO₃)₃ with M=Al, Y or a mixture of the two compounds and 0≤x≤0.8; Li₃BO₃, Li₃BO₃—Li₂SO₄, Li₃BO₃—Li₂SiO₄, Li₃BO₃—Li₂SiO₄—Li₂SO₄;
oxinitrides, preferably chosen from Li₃PO₄₋ₓN_{2x/3}, Li₄SiO₄₋ₓN_{2x/3}, L-i₄GeO₄₋ₓN_{2x/3} with 0<x<4 or Li3BO₃₋ₓN_{2x/3} with 0<x<3;
lithium compounds based on lithium and phosphorus oxinitride (called LiPON) in the form LiₓPO_{y}N_{z} with x˜2.8 and 2y+3z˜7.8 and 0.16≤z≤0.4, and in particular Li_{2.9}PO_{3.3}N_{0.46}, but also the compounds Li_{w}POₓN_{y}S_{z} with 2x+3y+2z=5=w or the compounds Li_{w}POₓN_{y}S_{z} with 3.2≤x≤3.8, 0.13≤y≤0.4, 0≤z≤0.2, 2.9≤w≤3.3 or the compounds in the form of LiₜPₓAl_{y}OᵤN_{y}S_{w} with 5x+3y=5, 2u+3v+2w=5+t, 2.9≤t≤3.3, 0.84≤x≤0.94, 0.094≤y≤0.26, 3.2≤u≤3.8, 0.13≤v≤0.46, 0≤w≤0.2;
materials based on lithium phosphorus or boron oxinitrides (called LiPON and LIBON) also able to contain silicon, sulfur, zirconium, aluminum, or a combination of aluminum, boron, sulfur and/or silicon, and boron for the materials based on lithium phosphorus oxinitrides;
lithium compounds based on lithium, phosphorus and silicon oxinitride called LiSiPON, and particularly Li_{1.9}Si_{0.28}P_{1.0}O_{1.1}N_{1.0};
lithium oxinitrides of the LiBON, LiBSO, LiSiPON, LiSON, thio-LiSiCON, LiPONB types (where B, P and S represent boron, phosphorus and sulfur respectively);
lithium oxides, preferably chosen from Li₇La₃Zr₂O₁₂ or Li₅₊ₓLa₃(Zrₓ,A₂₋ₓ)O₁₂ with A=Sc, Y, Al, Ga and 1.4≤x≤2 or Li_{0.35}La_{0.55}TiO₃ or Li₃ₓLa_{2/3-x}TiO₃ with 0≤x≤0.16 (LLTO);
silicates, preferably chosen from Li₂Si₂O₅, Li₂SiO₃, Li₂Si₂O₆, LiAlSiO₄, Li₄SiO₄, LiAlSi₂O₆;
solid electrolytes of the anti-perovskite type chosen from: Li₃OA with A a halide or a mixture of halides, preferably at least one of the elements chosen from F, Cl, Br, I or a mixture of two or three or four of these elements; Li₍₃₋ₓ₎M_{x/2}OA with 0<x≤3, M a divalent metal, preferably at least one of the elements Mg, Ca, Ba, Sr or a mixture of two or three or four of these elements, A a halide or a mixture of halides, preferably at least one of the elements F, Cl, Br, I or a mixture of two or three or four of these elements; Li₍₃₋ₓ₎M³_{x/3}OA with 0≤x≤3, M³ a trivalent metal, A a halide or a mixture of halides, preferably at least one of the elements F, Cl, Br, I or a mixture of two or three or four of these elements; or LiCOX_{z}Y_{(1-z)}, with X and Y halides such as mentioned hereinabove in relation with A, and 0≤z≤1,
the compounds La_{0.51}Li_{0.34}Ti_{2.94}, Li_{3.}V_{0.4}Ge_{0.6}O₄, Li₂O—Nb₂O₅, LiAlGeSPO₄;
formulations based on Li₂CO₃, B₂O₃, Li₂O, Al(PO₃)₃LiF, P₂5₃, Li₂S, Li₃N, Li₁₄Zn(GeO₄)₄, Li_{3.6}Ge_{0.6}V_{0.4}O₄, LiTi₂(PO₄)₃, Li_{3.25}Ge_{0.25}P_{0.25}S₄, Li_{1.3}Al_{0.3}Ti_{1.7}(PO₄)₃, Li₁₊ₓAlₓM₂₋ₓ(PO₄)₃ (where M=Ge, Ti, and/or Hf, and where 0<x<1), Li_{1+x+y}AlₓTi₂₋ₓSi_{y}P_{3-y}O₁₂(where 0≤x≤1 and 0≤y≤1).

Regarding the morphology of these electrolyte layers, different types of lithium-ion-conducting electrolyte layers can be used in the context of this invention. A dense layer can be used, such as known in document WO 2013/064 772. A porous layer can also be used, preferably mesoporous, that can be impregnated with a polymer or an ionic liquid including lithium ions; this will be described in greater detail hereinbelow.

The cathode of a battery according to the invention can be done from a cathode material chosen from:
oxides LiMn₂O₄, Li₁₊ₓMn₂₋ₓO₄ with 0<x<0.15, LiCoO₂, LiNiO₂, LiMn_{1.5}Ni_{0.5}O₄, LiMn_{1.5}Ni_{0.5-x}XₓO₄ where X is selected from Al, Fe, Cr, Co, Rh, Nd, rare earths such as Sc, Y, Lu, La, Ce, Pr, Pm, Sm, Eu, Gd, Tb, Dy, Ho, Er, Tm, Yb, and where 0<x<0.1, LiMn₂₋ₓMₓO₄ with M=Er, Dy, Gd, Tb, Yb, Al, Y, Ni, Co, Ti, Sn, As, Mg or a mixture of these compounds and where 0<x<0.4, LiFeO₂, LiMn_{1/3}Ni_{1/3}C0_{1/3}O₂, LiAlₓMn₂₋ₓO₄ with 0≤x<0.15, LiNi_{1/x}Co_{1/y}Mn_{1/z}O₂ with x+y+z=10;
phosphates LiFePO₄, LiMnPO₄, LiCoPO₄, LiNiPO₄, Li₃V₂(PO₄)₃; phosphates of formula LiMM′PO₄, with M and M′ (M≠M′) selected from Fe, Mn, Ni, Co, V;
all lithium forms of the following chalcogenides: V₂O₅, V₃O₈, TiS₂, titanium oxysulfides (TiO_{y}S, with z=2−y and 0.3≤y≤1), tungsten oxysulfides (WO_{y}S_{z} with z=2−y and 0.3≤y≤), CuS, CuS₂.

### 7. Variants of the Invention

The invention can be implemented with a porous anode and/or a cathode, preferably mesoporous. Such a thin-layer porous electrode, deposited on a substrate, advantageously has a thickness less than 10 μm, preferably less than 8 μm, and even more preferably comprised between 1 μm and 6 μm. It is binder-free. It has pores with an average diameter less than 100 nm, preferably less than 80 nm. Its porosity is advantageously greater than 30% by volume, preferably comprised between 30% and 55% by volume, more preferably between 35% and 50%, and even more preferably between 40% and 50%.

A porous anode or cathode, preferably mesoporous, can be manufactured by a method wherein:
(A) A colloidal suspension is provided, containing aggregates or agglomerates of nanoparticles of at least one material P having an average primary diameter D₅₀ of less than or equal to 50 nm (preferably between 10 nm and 30 nm), said aggregates or agglomerates having an average diameter comprised between 80 nm and 300 nm (preferably between 100 nm to 200 nm),
(B) a substrate is immersed in said colloidal suspension provided in step (A), jointly with a counter electrode,
(C) an electrical voltage is applied between said substrate and said counter electrode so as to obtain the electrophoretic deposition of an electrode layer comprising aggregates of nanoparticles of said at least one material P on said substrate,
(D) said layer is dried, preferably beneath an air flow, knowing that steps (B), (C) and (D) can be repeated.

Said material P is an anode material, for manufacturing a porous anode, or a cathode material, for manufacturing a porous cathode.

In an alternative, this method includes the following steps:
(A1) a colloidal suspension is provided including nanoparticles of at least one material P with a primary diameter D₅₀ less than or equal to 50 nm;
(A2)the nanoparticles present in said colloidal suspension are destabilized so as to form clusters of particles with an average diameter comprised between 80 nm and 300 nm, preferably between 100 nm and 200 nm, said destabilization being done preferably by adding a destabilizing agent such as a salt, preferably LiOH;
(B) a substrate is immersed in said colloidal suspension comprising the aggregates or agglomerates of nanoparticles obtained in step (A2), jointly with a counter electrode;
(C) an electrical voltage is applied between said substrate and said counter electrode so as to obtain the electrophoretic deposition of an electrode layer comprising aggregates of nanoparticles of said at least one material P on said substrate,
(D) said layer is dried, preferably beneath an air flow.

In order to obtain by this method a porous electrode layer, a specific treatment of the layer obtained at the end of step (D) must be carried out. The dried layers can be consolidated by a step of pressing and/or heating. In a very advantageous embodiment of the invention this treatment leads to a partial coalescence of the primary nanoparticles in the aggregates, and between neighboring aggregates; this phenomenon is called “necking” or “neck formation”. It is characterized by the partial coalescence of two particles in contact, which remain separated by connected by a neck (shrinkage). The lithium ions are mobile within these necks and can diffuse from one particle to the other without encountering grain boundaries. Thus a three-dimensional network of interconnected particles with strong ion mobility and electronic conduction; this network includes pores, preferably mesopores. The temperature required to obtain “necking” depends on the material; in light of the diffusive nature of the phenomenon that leads to necking the duration of the treatment depends on the temperature.

The average diameter of the pores is comprised between 2 nm and 80 nm, preferable comprised between 2 nm and 50 nm, preferably comprised between 6 nm and 30 nm and even more preferably between 8 nm and 20 nm.

According to this alternative, during the deposition of the protection coating by ALD or by CSD on the porous anode, the protective coating is deposited on the pores of the porous anode material and inside pores of said porous anode material. The total thickness of the protective coating of the porous anodes should not exceed 10 nm, and preferably remain less than 5 nm, so as to not obstruct said pores.

For the first layer of the protective coating, an electrically insulating material is preferably chosen, which can in particular be alumina, silica or zirconia, or a lithium-ion-conducting solid electrolyte of the Li₃PO₄; its thickness is advantageously comprised between 1 nm and 5 nm, preferably 2 nm and 4 nm. Advantageously, the thickness of this first layer of the protective coating is comprised between 1 nm and 3 nm if then a second layer is deposited. Advantageously, after the deposition by ALD or by CSD of a layer of an electronically insulating material or of a solid electrolyte, is carried out a deposition of a second thin layer of at least one solid electrolyte by dipping or by electrophoresis is carried out from a suspension including monodispersed nanoparticles of at least one solid electrolyte material.

The second layer of the protective coating can be a solid electrolyte material chosen from the group formed by:
phosphates such Li₃PO₄, LiPO₃, (Li₃Al_{0.4}Sc_{1.6}(PO₄)₃, Li_{1.2}Zr_{1.9}Ca_{0.1}(PO₄)₃; LiZr₂(PO₄)₃; Li₁₊₃ₓZr₂(P₁₋ₓSiₓO₄)₃ with 1.8<x<2.3; Li₁₊₆ₓZr₂(P₁₋ₓBₓO₄)₃ with 0≤x≤0.25; Li₃(Sc₂₋ₓMₓ)(PO₄)₃ with M=Al or Y and 0≤x≤1; Li₁₊ₓMₓ(Sc)₂₋ₓ(PO₄)₃ with M=Al, Y, Ga or a mixture of the three compounds and 0≤x≤0.8; Li₁₊ₓMₓ(Ga_{1-y}Sc_{y})₂₋ₓ(PO₄)₃ with 0≤x≤0.8; 0≤y≤1 and M=Al or Y or a mixture of the two compounds; Li₁₊ₓMₓ(Ga)₂₋ₓ(PO₄)₃ with M=Al, Y or a mixture of the two compounds and 0≤x≤0.8; Li₁₊ₓAlₓTi₂₋ₓ(PO₄)₃ with 0≤x≤1, Li_{1.3}Al_{0.3}Ti_{1.7}(PO₄)₃, or Li₁₊ₓAlₓGe₂₋ₓ(PO₄)₃ with 0≤x≤1; or Li_{1+x+z}Mₓ(Ge_{1-y}Ti_{y})₂₋ₓSi_{z}P_{3-z}O₁₂ with 0≤x≤0.8 and 0≤y≤1.0 & 0≤z≤0.6 and M=Al, Ga or Y or a mixture of two or three of these compounds; Li_{3+y}(Sc₂₋ₓMₓ)Q_{y}P_{3-y}O₁₂, with M=Al and/or Y and Q=Si and/or Se, 0≤x≤0.8 and 0≤y≤1; or Li_{1+x+y}MₓSc₂₋ₓQ_{y}P_{3-y}O₁₂, with M=Al, Y, Ga or a mixture of the three compounds and Q=Si and/or Se, 0≤x≤0.8 and 0≤y≤1; or Li_{1+x+y+z}Mₓ(Ga_{1-y}Sc_{y})₂₋ₓQ_{z}P_{3-z}O₁₂ with 0≤x≤0.8; 0≤y≤1; 0≤z≤0.6 with M=Al or Y or a mixture of the two compounds and Q=Si and/or Se; or Li₁₊ₓZr₂₋ₓBₓ(PO₄)₃ with 0≤x≤0.25; or Li₁₊ₓZr₂₋ₓCaₓ(PO₄)₃ with 0≤x≤0.25; or Li₁₊ₓNₓM₂₋ₓP₃O₁₂, with 0≤x≤1 and N=Cr, V, Ca, B, Mg, Bi and/or Mo, M=Sc, Sn, Zr, Hf, Se or Si, or a mixture of these compounds;
borates such as Li₃BO₃, LiBO₂, Li₃(Sc₂₋ₓMₓ)(BO₃)₃ with M=Al or Y and 0≤x≤1; Li₁₊ₓMₓ(Sc)₂₋ₓ(BO₃)₃ with 0≤x≤0.8 and M=Al, Y, Ga or a mixture of the three compounds; Li₁₊ₓMₓ(Ga_{1-y}Sc_{y})₂₋ₓ(BO₃)₃ with 0≤x≤0.8; 0≤y≤1 and M=Al or Y; Li₁₊ₓMₓ(Ga_{1-y}Sc_{y})₂₋ₓ(BO₃)₃ with M=Al, Y or a mixture of the two compounds and 0≤x≤0.8; Li₃BO₃—Li₂SO₄, Li₃BO₃—Li₂SiO₄, Li₃BO₃—Li₂SiO₄—Li₂SO₄;
silicates such as Li₂SiO₃, Li₂Si₅O₁₁, Li₂Si₂O₅, Li₂SiO₆, LiAlSiO₄, Li₄SiO₄, LiAlSi₂O₆;
oxides such as a coating of Al₂O₃, LiNbO₃;
fluorides such as AlF₃, LaF₃, CaF₂, LiF, CeF₃;
compounds of the anti-perovskite type chosen from: Li₃OA with A a halide or a mixture of halides, preferably at least one of the elements chosen from F, Cl, Br, I or a mixture of two or three or four of these elements; Li₍₃₋ₓ)M_{x/2}OA with 0<x≤3, M a divalent metal, preferably at least one of the elements Mg, Ca, Ba, Sr or a mixture of two or three or four of these elements, A a halide or a mixture of halides, preferably at least one of the elements F, Cl, Br, I or a mixture of two or three or four of these elements; Li₍₃₋ₓ₎M³_{x/3}OA with 0≤x≤3, M³ a trivalent metal, A a halide or a mixture of halides, preferably at least one of the elements F, Cl, Br, I or a mixture of two or three or four of these elements; or LiCOX_{z}Y_{(1-z}), with X and Y halides such as mentioned hereinabove in relation with A, and 0≤z≤1,
a mixture of different compositions contained in said group.

The porous electrode can advantageously by impregnated by an electrolyte, which is preferably an ionic liquid comprising a lithium salt; said ionic liquid can be diluted with an aprotic solvent.

In another alternative of the invention the cathode material is also coated with a protective coating; the same methods can be used as for protecting the anode materials. More precisely, the cathode material, deposited on an electronically conductive substrate able to be used as a cathode current collector, is coated with a protective coating in contact with said cathode material, said protective coating being able to protect this cathode material from the atmosphere of the environment.

### EXAMPLES

The example hereinbelow show certain aspects of the invention but do not limit the scope of it.

### Example 1: Manufacture of a Precharged Anode

A suspension of the anode material was prepared by grinding/dispersion a Li₄Ti₅O₁₂ powder in absolute ethanol at about 10 g/L with a few ppm of citric acid. The grinding was carried out in such a way as to obtain a stable suspension with a particle size D₅₀ less than 70 nm.

An anode layer was deposited by electrophoresis of the nanoparticles of Li₄Ti₅O₁₂ contained in the suspension; this layer was deposited on the two faces of a first substrate with a thickness of 1 μm; it was dried and thermally treated at about 600° C. This anode layer was a so-called “dense” layer, having undergone a step of thermal consolidation that leads to the increase in the density of the layer.

The anode was then coated with a protective coating of Li₃PO₄ of a thickness of 10 nm deposited by ALD. Then a layer of ceramic electrolyte Li₃Al_{0.4}Sc_{1.6}(PO₄)₃ (abbreviated LASP) was deposited on this anode layer by electrophoresis; the thickness of this layer of LASP was about 500 nm. This electrolyte layer was then dried and consolidated by heat treatment at about 600° C.

The anode was then immersed in a solution of LiPF₆/EC/DMC, with a counter electrode made of metal lithium and charged to 1.55 V. The capacity of this anode on its reversible plateau at 1.55 V was greater than the capacity of the cathode.

### Example 2: Manufacture of a Battery Comprising a Precharged Anode

A suspension was prepared at about 10 g/L of cathode material by grinding/dispersion of a LiMn₂O₄ powder in water. A suspension was also prepared at 5 g/L of ceramic electrolyte material by grinding/dispersion of a Li₃Al_{0.4}Sc_{1.6}(PO₄)₃ in absolute ethanol. The grinding was carried out in such a way as to obtain stable suspensions with a particle size D₅₀ less than 50 nm.

A cathode was prepared by electrophoretic deposition of nanoparticles of LiMn₂O₄ contained in the suspension described hereinabove, in the form of a thin film deposited on the two faces of a second substrate; this cathode layer of thickness 1 μm was then thermally treated at about 600° C.

Then the anode obtained in example 1 and the cathode were stacked on their electrolyte faces and the whole was maintained under pressure for 15 minutes at 500° C.; a lithium-ion battery was thus obtained that was able to be charged and discharges in many cycles.

1. Anode for a lithium-ion battery, including at least one anode material and being binder-free, said anode being precharged with lithium ions, characterized in that said anode material, deposited on an electronic conductor substrate capable of serving as anode current collector, is coated with a protective coating in contact with said anode material, said protective coating being capable of protecting said anode material from the atmosphere of the environment.

2. Anode according to claim 1, characterized in that said anode can be manufactured by a chemical vapor deposition technique, in particular by a physical vapor deposition technique such as cathode sputtering, and/or by a chemical vapor deposition technique, possibly plasma assisted.

3. Anode according to claim 1, characterized in that said anode can be manufactured by an electrophoretic deposition technique from a suspension of nanoparticles of at least one anode material.

4. Anode according to any of claims 1 to 3, characterized in that said anode material is chosen from the group formed by:
carbon nanotubes, graphene, graphite;
lithium iron phosphate, of typical formula LiFePO₄;
mixed silicon and tin oxinitrides, of typical formula SiₐSn_{b}O_{y}N_{z} with a>0, b>0, a+b≤2, 0<y≤4, 0<z≤, also called SiTON, and in particular SiSn_{0.87}O_{1.2}N_{1.72};
oxynitride carbides of typical formula SiₐSn_{b}C_{c}O_{y}N_{z} with a>0, b>0, a+b≤2, 0<c<10, 0<y<24, 0<z<17;
nitrides of the type SiₓN_{y}, in particular with x=3 and y=4; of type SnₓN_{y}, in particular with x=3 and y=4; of type ZnₓN_{y}, in particular with x=3 and y=2; of type Li₃₋ₓMₓN with 0≤x≤0.5 for M=Co, 0≤x≤0.6 for M=Ni, and 0≤x≤0.3 for M=Cu; or of type Si₃₋ₓMₓN₄ with 0≤x≤3;
oxides SnO₂, SnO, Li₂SnO₃, SnSiO₃, LiₓSiO_{y} (x>=0 and 2>y>0), Li₄Ti₅O₁₂, TiNb₂O₇, Co₃O₄, SnB_{0.6}P_{0.4}O_{2.9} and TiO₂,
composite oxides TiNb₂O₇ comprising between 0% and 10% carbon by weight, preferably carbon being chosen from graphene and the carbon nanotubes.

5. Anode according to any of claims 3 or 4, characterized in that it is porous, preferably mesoporous.

6. Anode according to any of claims 1 to 5, characterized in that said protective coating comprises a first layer, in contact with the anode material, deposited by the ALD technique (Atomic Layer Deposition) or chemically in a solution CSD, which has a thickness less than 10 nm, preferably less than 5 nm, and that is even more preferably comprised between 1 nm and 3 nm.

7. Anode according to claim 6, characterized in that said this first layer is an electronic insulator oxide, preferably selected from the group formed by silica, alumina and zirconia.

8. Anode according to any of claims 6 to 7, characterized in that said protective coating comprises a second layer, deposited on top of the first layer, that is made of a material selected from the group formed by:
phosphates such as Li₃PO_{4,} LiPO₃, (Li₃Al_{0.4}Sc_{1.6}(PO₄)₃, Li_{1.2}Zr_{1.9}Ca_{0.1}(PO₄)₃; LiZr₂(PO₄)₃; Li₁₊₃ₓZr₂(P₁₋ₓSiₓO₄)₃ with 1.8<x<2.3; Li_{1.6x}Zr₂(P₁₋ₓBₓO₄)₃ with 0≤x≤0.25; Li₃(Sc₂₋ₓMₓ)(PO₄)₃ with M=Al or Y and 0≤x≤1; Li₁₊ₓMₓ(Sc)₂₋ₓ(PO₄)₃ with M=Al, Y, Ga or a mixture of the three compounds and 0≤x≤0.8; Li₁₊ₓMₓ(Ga_{1-y}Sc_{y})₂₋ₓ(PO₄)₃ with 0≤x≤0.8; 0≤y≤1 and M=Al or Y or a mixture of the two compounds; Li₁₊ₓMₓ(Ga)₂₋ₓ(PO₄)₃ with M=Al, Y or a mixture of the two compounds and 0≤x≤0.8; Li₁₊ₓAlₓTi₂₋ₓ(PO₄)₃ with 0≤x≤1, Li_{1.3}Al_{0.3}Ti_{1.7}(PO₄)₃, or Li₁₊ₓAlₓGe₂₋ₓ(PO₄)₃ with 0≤x≤1; or Li_{1+x+z}Mₓ(Ge_{1-y}Ti_{y})₂₋ₓSi_{z}P_{3-z}O₁₂ with 0≤x≤0.8 and 0≤y≤1.0 & 0≤z≤1.6 and M=Al, Ga or Y or a mixture of two or three of these compounds; Li_{3+y}(Sc₂₋ₓMₓ)Q_{y}P_{3-y}O₁₂, with M=Al and/or Y and Q=Si and/or Se, 0≤x≤0.8 and 0≤y≤1; or Li_{1+x+y}MₓSc₂₋ₓQ_{y}P_{3-y}O₁₂, with M=Al, Y, Ga or a mixture of the three compounds and Q=Si and/or Se, 0≤x≤0.8 and 0≤y≤1; or Li_{1+x+y+z}Mₓ(Ga_{1-y}Sc_{y})₂₋ₓQ_{z}P_{3-z}O₁₂ with 0≤x≤0.8; 0≤y≤1; 0≤z≤0.6 with M=Al or Y or a mixture of the two compounds and Q=Si and/or Se; or Li₁₊ₓZr₂₋ₓBₓ(PO₄)₃ with 0≤x≤0.25; or Li₁₊ₓZr₂₋ₓCaₓ(PO₄)₃ with 0≤x≤0.25; or Li₁₊ₓNₓM₂₋ₓP₃O₁₂, with 0≤x≤1 and N=Cr, V, Ca, B, Mg, Bi and/or Mo, M=Sc, Sn, Zr, Hf, Se or Si, or a mixture of these compounds;
borates such as Li₃BO₃, LiBO₂, Li₃(Sc₂₋ₓMₓ)(BO₃)₃ with M=Al or Y and 0≤x≤1; Li₁₊ₓMₓ(Sc)₂₋ₓ(BO₃)₃ with 0≤x≤0.8 and M=Al, Y, Ga or a mixture of the three compounds; Li₁₊ₓMₓ(Ga_{1-y}Sc_{y})₂₋ₓ(BO₃)₃ with 0≤x≤0.8; 0≤y≤1 and M=Al or Y; Li₁₊ₓMₓ(Ga)₂₋ₓ(BO₃)₃ with M=Al, Y or a mixture of the two compounds and 0≤x≤0.8; Li₃BO₃—Li₂SO₄, Li₃BO₃—Li₂SiO₄, Li₃BO₃—Li₂SiO₄—Li₂SO₄;
silicates such as Li₂SiO₃, Li₂Si₅O₁₁, Li₂Si₂O₅, Li₂SiO₆, LiAlSiO₄, Li₄SiO₄, LiAlSi₂O₆;
oxides such as a coating of Al₂O₃, LiNbO₃;
fluorides such as AlF₃, LaF₃, CaF₂, LiF, CeF₃;
compounds of the anti-perovskite type chosen from: Li₃OA with A a halide or a mixture of halides, preferably at least one of the elements chosen from F, Cl, Br, I or a mixture of two or three or four of these elements; Li₍₃₋ₓ₎M_{x/2}OA with 0<x≤3, M a divalent metal, preferably at least one of the elements Mg, Ca, Ba, Sr or a mixture of two or three or four of these elements, A a halide or a mixture of halides, preferably at least one of the elements F, Cl, Br, I or a mixture of two or three or four of these elements; Li₍₃₋ₓ₎M³_{x/3}OA with 0≤x≤3, M³ a trivalent metal, A a halide or a mixture of halides, preferably at least one of the elements F, Cl, Br, I or a mixture of two or three or four of these elements; or LiCOX_{z}Y_{(1-z)}, with X and Y halides such as mentioned hereinabove in relation with A, and 0≤z≤1,
a mixture of different compositions contained in said group.

9. Anode according to any of claims 1 to 5, characterized in that said protective coating comprises at least one compound chosen from the group formed by:
garnets, preferably chosen from: Li₇La₃Zr₂O₁₂; Li₆La₂BaTa₂O₁₂; Li_{5.5}La₃Nb_{1.75}In_{0.25}O₁₂; Li₅La₃M₂O₁₂ with M=Nb or Ta or a mixture of the two compounds; Li₇₋ₓBaₓLa₃₋ₓM₂O₁₂ with 0≤x≤1 and M=Nb or Ta or a mixture of the two compounds; Li₇₋ₓLa₃Zr₂₋ₓMₓO₁₂ with 0≤x≤2 and M=Al, Ga or Ta or a mixture of two or three of these compounds;
lithium phosphates, preferably chosen from: Li₃PO₄; LiPO₃; Li₃Al_{0.4}Sc_{1.6}(PO₄)₃ under the acronym LASP, Li_{1.2}Zr_{1.9}Ca_{0.1}(PO₄)₃; LiZr₂(PO₄)₃; Li₁₊₃ₓZr₂(P₁₋ₓSiₓO₄)₃ with 1.8<x<2.3; Li₁₊₆ₓZr₂(P₁₋ₓBₓO₄)₃ with 0≤x≤0.25; Li₃(Sc₂₋ₓMₓ)(PO₄)₃ with M=Al or Y and 0≤x≤1; Li₁₋ₓMₓ(Sc)₂₋ₓ(PO₄)₃ with M=Al, Y, Ga or a mixture of the three compounds and 0≤x≤0.8; Li₁₊ₓMₓ(Ga_{1-y}Sc_{y})₂₋ₓ(PO₄)₃ with 0≤x≤0.8; 0≤y≤1 and M=Al or Y or a mixture of the two compounds; Li₁₊ₓMₓ(Ga)₂₋ₓ(PO₄)₃ with M=Al, Y or a mixture of the two compounds and 0≤x≤0.8; Li₁₊ₓAlₓTi₂₋ₓ(PO₄)₃ with 0≤x≤1, Li_{1.3}Al_{0.3}Ti_{1.7}(PO₄)₃, or Li₁₊ₓAlₓGe₂₋ₓ(PO₄)₃ with 0≤x≤1; or Li_{1+x+z}Mₓ(Ge_{1-y}Ti_{y})₂₋ₓSi_{z}P_{3-z}O₁₂ with 0≤x≤0.8 and 0≤y≤1.0 & 0≤z≤0.6 and M=Al, Ga or Y or a mixture of two or three of these compounds; Li_{3+y}(Sc₂₋ₓMₓ)Q_{y}P_{3-y}O₁₂, with M=Al and/or Y and Q=Si and/or Se, 0≤x≤0.8 and 0≤y≤1; or Li_{1+x+y}MₓSc₂₋ₓQ_{y}P_{3-y}O₁₂, with M=Al, Y, Ga or a mixture of the three compounds and Q=Si and/or Se, 0≤x≤0.8 and 0≤y≤1; or Li_{1+x+y+z}Mₓ(Ga_{1-y}Sc_{y})₂₋ₓQ_{z}P_{3-z}O₁₂ with 0≤x≤0.8; 0≤y≤1; 0≤z≤0.6 with M=Al or Y or a mixture of the two compounds and Q=Si and/or Se; or Li₁₊ₓZr₂₋ₓBₓ(PO₄)₃ with 0≤x≤0.25; or Li₁₊ₓZr₂₋ₓCaₓ(PO₄)₃ with 0≤x≤0.25; or Li₁₊ₓNₓM₂₋ₓP₃O₁₂, with 0≤x≤1 and N=Cr, V, Ca, B, Mg, Bi and/or Mo, M=Sc, Sn, Zr, Hf, Se or Si, or a mixture of these compounds;
lithium borates, preferably chosen from: Li₃(Sc₂₋ₓMₓ)(BO₃)₃ with M=Al or Y and 0≤x≤1; Li₁₊ₓMₓ(Sc)₂₋ₓ(BO₃)₃ with M=Al, Y, Ga or a mixture of the three compounds and 0≤x≤0.8; Li₁₊ₓMₓ(Ga_{1-y}Sc_{y})₂₋ₓ(BO₃)₃ with 0≤x≤0.8; 0≤y≤1 and M=Al or Y; Li₁₊ₓMₓ(Ga)₂₋ₓ(BO₃)₃ with M=Al, Y or a mixture of the two compounds and 0≤x≤0.8; Li₃BO₃, LiBO₂, Li₃BO₃—Li₂SO₄, Li₃BO₃—Li₂SiO₄, Li₃BO₃—Li₂SiO₄—Li₂SO₄;
oxinitrides, preferably chosen from Li₃PO₄₋ₓN_{2x/3}, Li₄SiO₄₋ₓN_{2x/3}, Li₄GeO₄₋ₓN_{2x/3} with 0<x<4 or Li₃BO₃₋ₓN_{2x/3} with 0<x<3;
lithium compounds based on lithium and phosphorus oxinitride (called LiPON) in the form LiₓPO_{y}N_{z} with x˜2.8 and 2y+3z˜7.8 and 0.16≤z≤0.4, and in particular Li_{2.9}PO_{3.3}N_{0.46}, but also the compounds Li_{w}POₓN_{y}S_{z} with 2x+3y+2z=5=w or the compounds Li_{w}POₓN_{y}S_{z} with 3.2≤x≤3.8, 0.13≤y≤0.4, 0≤z≤0.2, 2.9≤w≤3.3 or the compounds in the form of LiₜPₓAl_{y}OᵤNᵥS_{w} with 5x+3y=5, 2u+3v+2w=5+t, 2.9≤t≤3.3, 0.84≤x≤0.94, 0.094≤y≤0.26, 3.2≤u≤3.8, 0.13≤v≤0.46, 0≤w≤0.2;
materials based on lithium phosphorus or boron oxinitrides (called LiPON and LIBON) also able to contain silicon, sulfur, zirconium, aluminum, or a combination of aluminum, boron, sulfur and/or silicon, and boron for the materials based on lithium phosphorus oxinitrides;
lithium compounds based on lithium, phosphorus and silicon oxinitride called LiSiPON, and particularly Li_{1.9}Si_{0.28}P_{1.0}O_{1.1}N_{1.0};
lithium oxinitrides of the LiBON, LiBSO, LiSiPON, LiSON, thio-LiSiCON, LiPONB types (where B, P and S represent boron, phosphorus and sulfur respectively);
lithium oxides, preferably chosen from Li₇La₃Zr₂O₁₂ or Li₅₊ₓLa₃(Zrₓ,A₂₋ₓ)O₁₂ with A=Sc, Y, Al, Ga and 1.4≤x≤2 or Li_{0.35}La_{0.55}TiO₃ or Li₃ₓLa_{2/3-x}TiO₃ with 0≤x≤0.16;
silicates, preferably chosen from Li₂Si₂O₅, Li₂SiO₃, Li₂SiO₆, Li₂Si₂O₆, LiAlSiO₄, Li₄SiO₄, LiAlSi₂O₆, Li₂Si₅O₁₁;
solid electrolytes of the anti-perovskite type chosen from: Li₃OA with A a halide or a mixture of halides, preferably at least one of the elements chosen from F, Cl, Br, I or a mixture of two or three or four of these elements; Li₍₃₋ₓ₎M_{x/2}OA with 0<x≤3, M a divalent metal, preferably at least one of the elements Mg, Ca, Ba, Sr or a mixture of two or three or four of these elements, A a halide or a mixture of halides, preferably at least one of the elements F, Cl, Br, I or a mixture of two or three or four of these elements; Li₍₃₋ₓ₎M³_{x/3}OA with 0≤x≤3, M³ a trivalent metal, A a halide or a mixture of halides, preferably at least one of the elements F, Cl, Br, I or a mixture of two or three or four of these elements; or LiCOX_{z}Y_{(1-z)}, with X and Y halides such as mentioned hereinabove in relation with A, and 0≤z≤1,
the compounds La_{0.51}Li_{0.34}Ti_{2.94}, Li_{3.4}V_{0.4}Ge_{0.6}O₄, Li₂O—Nb₂O₅, LiAlGaSPO₄;
formulations based on Li₂CO₃, B₂O₃, Li₂O, Al(PO₃)₃LiF, P₂S₃, Li₂S, Li₃N, Li₁₄Zn(GeO₄)₄, Li_{3.6}Ge_{0.6}V_{0.4}O₄, LiTi₂(PO₄)₃, Li_{3.25}Ge_{0.25}P_{0.25}S₄, Li_{1.3}Al_{0.3}Ti_{1.7}(PO₄)₃, Li₁₊ₓAlₓM₂₋ₓ(PO₄)₃ (where M=Ge, Ti, and/or Hf, and where 0<x<1), Li_{1+x+y}AlₓTi₂₋ₓSi_{y}P_{3-y}O₁₂(where 0≤x≤1 and 0≤y≤1), LiNbO₃.

10. Method for manufacturing an anode for a lithium-ion battery according to one of claims 1 to 9, comprising the steps of:
(a) Deposition of an anode material on said substrate;
(b) Deposition of a protective coating on said anode material;
(c) Charging said anode material with lithium ions by polarization in a solution containing lithium cations.

11. Method according to claim 10, wherein the deposition of said anode material is done by a chemical vapor deposition technique, in particular by a physical vapor deposition technique such as cathode sputtering, and/or by a chemical vapor deposition technique, possibly plasma assisted.

12. Method according to claim 10, wherein the deposition of said anode material is done by electrophoresis from a suspension of nanoparticles of at least one anode material, or by dipping.

13. Method according to claim 12, wherein said suspension comprises nanoparticles of at least one anode material with a primary diameter D₅₀ less than or equal to 50 nm.

14. Method according to claim 12, wherein said suspension includes aggregates of nanoparticles of anode material.

15. Method according to any of claims 12 to 14, characterized in that said anode material is subjected to a drying, said drying taking place between the end of the deposition by electrophoresis and the beginning of the deposition of the protective coating.

16. Method according to claim 15, characterized in that said anode material is subjected after drying to an annealing, possibly preceded and/or accompanied by a pressing.

17. Method Anode according to any of claims 10 to 16, characterized in that said anode material is chosen from the group formed by:
carbon nanotubes, graphene, graphite;
lithium iron phosphate, of typical formula LiFePO4;
mixed silicon and tin oxinitrides, of typical formula SiₐSn_{b}O_{y}N_{z} with a>0, b>0, a+b≤2, 0<y≤4, 0<z≤3, also called SiTON, and in particular SiSn_{0.87}O_{1.2}N_{1.72};
oxynitride carbides of typical formula SiₐSn_{b}C_{c}O_{y}N_{z} with a>0, b>0, a+b≤2, 0<c<10, 0<y<24, 0<z<17;
nitrides of the type SiₓN_{y}, in particular with x=3 and y=4; of type SnₓN_{y}, in particular with x=3 and y=4; of type ZnₓN_{y}, in particular with x=3 and y=2; of type Li₃₋ₓMₓN with 0≤x≤0.5 for M=Co, 0≤x≤0.6 for M=Ni, and 0≤x≤0.3 for M=Cu; or of type Si₃₋ₓMₓN₄ with 0≤x≤3;
oxides SnO₂, SnO, Li₂SnO₃, SnSiO₃, LiₓSiO_{y} (x>=0 and 2>y>0), Li₄Ti₅O₁₂, TiNb₂O₇, Co₃O₄, SnB_{0.6}P_{0.4}O_{2.9} and TiO₂,
composite oxides TiNb₂O₇ comprising between 0% and 10% carbon by weight, preferably carbon being chosen from graphene and the carbon nanotubes.

18. Method according to any of claims 10 to 17, wherein the deposition of the protective coating comprises the deposition by ALD or chemically in a solution of a layer of an electronically insulating material, preferably selected from alumina, silica or zirconia, or from a lithium-ion-conducting solid electrolyte material, preferably Li₃PO₄, said protective coating having a thickness comprised between 1 nm and 5 nm, and preferably between 2 nm and 4 nm.

19. Method according to claim 18, wherein after the deposition by ALD or chemically in a solution of a layer of an electronically insulating material or of a solid electrolyte, is carried out a deposition of a thin layer of at least one solid electrolyte by dipping or by electrophoresis is carried out from a suspension including monodispersed nanoparticles of at least one solid electrolyte material.

20. Lithium-ion battery, including an anode according to one of claims 1 to 9, or including an anode that can be obtained by the method according to one of claims 1 to 19, and furthermore including an electrolyte in contact with said anode, and a cathode in contact with said electrolyte.

21. Battery according to claim 20, characterized in that said electrolyte is a conductor of lithium ions and is selected from the group formed by:
all-solid-state electrolytes deposited by vapor phase deposition,
all-solid-state electrolytes electrophoretically deposited,
the electrolytes formed by a separator impregnated with a liquid electrolyte, typically with an aprotic solvent comprising a lithium salt or ionic liquid containing one or more lithium salts or a mixture of the two,
the porous electrolytes, preferably mesoporous impregnated with a liquid electrolyte, typically with an aprotic solvent comprising a lithium salt or ionic liquid containing one or more lithium salts or a mixture of the two,
the electrolytes comprising a polymer impregnated with a liquid electrolyte and/or a lithium salt,
the electrolytes formed by a lithium-ion-conducting solid electrolyte material, and preferably one oxide, sulfide or phosphate.

22. Battery according to claim 20 or 21, characterized in that said cathode is an all-solid-state cathode or a porous cathode, preferably mesoporous.
